(19) United States
(12) Patent Application Publication
(10) Pub. No.: US 2018/0181877 A1
(43) Pub. Date: Jun. 28, 2018

(54) GENERATING A KNOWLEDGE BASE TO ASSIST WITH THE MODELING OF LARGE DATASETS

(71) Applicant: Futurewei Technologies, Inc., Plano, TX (US)

(72) Inventors: Zonghuan Wu, Cupertino, CA (US); Hui Zang, Cupertino, CA (US)

(21) Appl. No.: 15/390,305

(22) Filed: Dec. 23, 2016

(51) Int. Cl. G06N 99/00; G06F 17/30

(52) U.S. Cl. CPC G06N 99/005; G06F 17/30312; G06F 17/30598; G06F 17/30194; G06F 17/30477

(57) ABSTRACT

A system, computer-readable medium, and method are provided for tracking modeling of datasets. The method includes the steps of executing an exploration operation to generate a result and storing an entry in a database that correlates an exploration operation configuration for the exploration operation with at least one performance metric. Each performance metric in the at least one performance metric is a value used to evaluate the result. The exploration operation utilizes a machine learning algorithm to process the dataset, and the exploration operation may be executed using at least one node in a computing cluster.

### FIELD OF THE INVENTION

The present invention relates to data mining, and more particularly to generating a knowledge base to assist in the configuration of modeling parameters when processing large datasets.

### BACKGROUND

Data mining using machine learning algorithms to analyze large datasets is a subfield of computer science that has applications in many industries. Companies offer various software services to analyze large datasets using a cluster of distributed nodes. For example, Microsoft® Azure Machine Learning Services is one such solution that is offered as software-as-a-service (SaaS). These tools enable data analysts to store data on a distributed database and analyze the data using various machine learning algorithms.

These tools typically enable a data analyst to select a particular dataset to analyze, select an algorithm to use to analyze the dataset, and set parameters within the algorithm to configure the analysis. There may be numerous algorithms and countless combinations of parameters that may be selected when analyzing the dataset. Conventionally, the configuration of the analysis is not saved such that data analysts must re-configure the software tool each time they want to run an analysis. Moreover, starting a new analysis with a new dataset will typically require the data analyst to reconfigure the analysis from scratch. Requiring the data analyst to reconfigure the software tool for each analysis wastes valuable time and can be the source of errors. For example, if a data analyst is trying to compare results from two different datasets, the results may not be comparable if each and every parameter is not setup in the same manner. Furthermore, many different data analysts may have already performed a similar analysis on the dataset, but the knowledge gained by other analysts cannot be leveraged by any one particular analyst.

### SUMMARY

A system, computer-readable medium, and method are provided for tracking modeling of datasets. The method includes the steps of executing an exploration operation to generate a result and storing an entry in a database that correlates an exploration operation configuration for the exploration operation with at least one performance metric. Each performance metric in the at least one performance metric is a value used to evaluate the result. The exploration operation utilizes a machine learning algorithm to process the dataset, and the exploration operation may be executed using at least one node in a computing cluster. The system includes a cluster including a plurality of nodes, the cluster including at least one node including a processor configured to perform the method. The computer-readable media stores computer instructions that, when executed by one or more processors, cause the one or more processors to perform the steps of the method.

In a first embodiment, the method further includes the step of generating the input for the machine learning algorithm based on the dataset. The input is generated by performing at least one of: extracting a plurality of samples from the dataset to include in the input; and calculating at least one value per sample for one or more derived features of the input. Each sample in the plurality of samples comprises one or more values corresponding to features of the input.

In a second embodiment (which may or may not be combined with the first embodiment), the configuration of the exploration operation comprises an identifier that specifies the dataset, an identifier that specifies the machine learning algorithm, a list of one or more features included in the input to the machine learning algorithm, a list of normalization methods corresponding to each feature of the one or more features, and a list of zero or more parameter values utilized to configure the machine learning algorithm.

In a third embodiment (which may or may not be combined with the first and/or second embodiments), the machine learning algorithm is selected from a group of algorithms consisting of a classification algorithm, a regression algorithm, or a clustering algorithm.

In a fourth embodiment (which may or may not be combined with the first, second, and/or third embodiments), the entry includes an elapsed time required to execute the exploration operation. Furthermore, the at least one performance metric includes at least one of an accuracy associated with the result, a precision associated with the result, a recall associated with the result, an F1 score associated with the result, and an Area Under Curve (AUC) associated with the result.

In a fifth embodiment (which may or may not be combined with the first, second, third, and/or fourth embodiments), the dataset is stored on a distributed file system. The distributed file system may be implemented across at least two nodes included in a computing cluster.

In a sixth embodiment (which may or may not be combined with the first, second, third, fourth, and/or fifth embodiments), the method further includes the steps of receiving a request to perform a second exploration operation and analyzing the entries in the database to determine a suggested configuration of the second exploration operation.

In a seventh embodiment (which may or may not be combined with the first, second, third, fourth, fifth, and/or sixth embodiments), determining a suggested configuration may comprise the steps of querying the database to select all entries associated with a second dataset corresponding to the second exploration operation and analyzing the selected entries to determine configurations utilized during previously executed exploration operations that maximize or minimize a particular performance metric.

In an eighth embodiment (which may or may not be combined with the first, second, third, fourth, fifth, sixth, and/or seventh embodiments), the method further includes the steps of displaying the suggested configuration within a graphical user interface.

To this end, in some optional embodiments, one or more of the foregoing features of the aforementioned apparatus, system, and/or method may afford a more efficient way to configure exploration operations of large datasets that, in turn, may enable data analysts to work more efficiently and reduce errors in the results obtained by the exploration operations. It should be noted that the aforementioned potential advantages are set forth for illustrative purposes only and should not be construed as limiting in any manner.

### BRIEF DESCRIPTION OF THE DRAWINGS

FIG. 1A illustrates a computing cluster, in accordance with an embodiment;

FIG. 1B illustrates a node of the computing cluster, in accordance with an embodiment;

FIG. 2 illustrates a modeling environment, in accordance with an embodiment;

FIG. 3 illustrates a data flow for an exploration operation, in accordance with an embodiment;

FIG. 4 illustrates a knowledge base maintained by the knowledge base module of FIG. 2, in accordance with an embodiment;

FIG. 5 illustrates a graphical user interface implemented by the integrated development environment of FIG. 2, in accordance with an embodiment;

FIG. 6A is a flowchart of a method for populating a knowledge base, in accordance with an embodiment; and

FIG. 6B is a flowchart of a method for utilizing the knowledge base to generate suggested exploration operation configurations for an exploration operation, in accordance with an embodiment.

### DETAILED DESCRIPTION

Analysis of large datasets may be performed by a data analyst by configuring an exploration operation. The term exploration operation, as used herein, refers to an algorithm executed to analyze a dataset. If the dataset is large, then the algorithm may be a machine learning algorithm. The configuration step may involve defining features of an input for a machine learning algorithm and setting parameter values for a number of parameters to configure the machine learning algorithm. Features can be extracted directly from the raw data in the dataset and/or derived from the data in the dataset. The selection of parameter values, algorithms, and features may have varying effects on the result of the exploration operation. A statistical analysis of the result may yield an accuracy, precision, recall or other metrics associated with the result that can inform the data analyst whether the particular model run by the exploration operation was effective. In other words, the performance metrics are values used to evaluate the result. The data analyst can then adjust the exploration operation configuration for the exploration operation to improve the result generated by the exploration operation.

It will be appreciated that the amount of care that the data analyst puts into configuring the exploration operation can have significant effects on the result. Therefore, it would be beneficial to leverage past work to inform the data analyst about which values to select to configure an exploration operation. In this pursuit, a knowledge base may be generated that tracks the modeling that has been performed in one or more previous exploration operations. This knowledge base can be used to determine how parameters will affect a particular performance metric associated with an exploration operation.

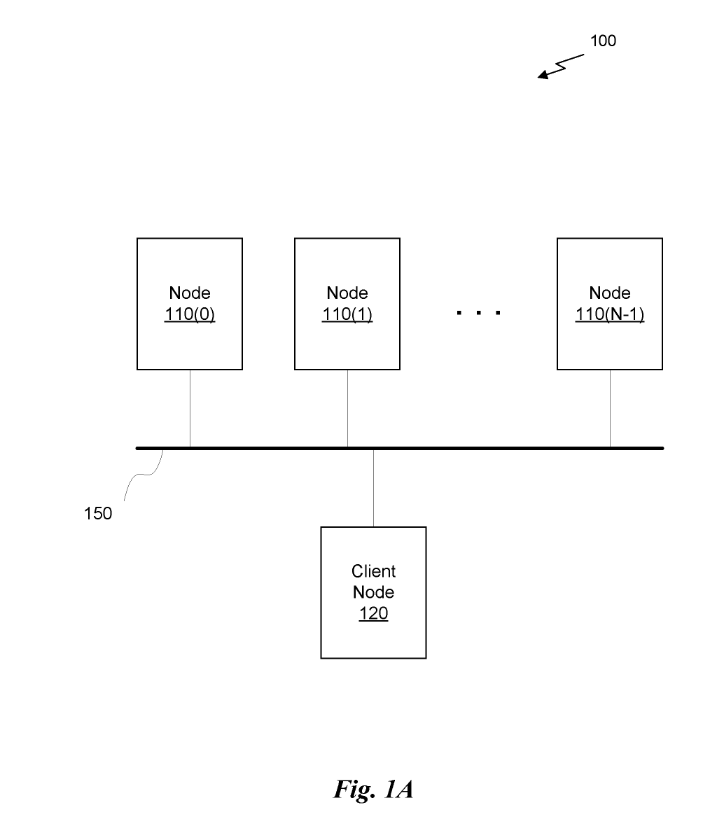

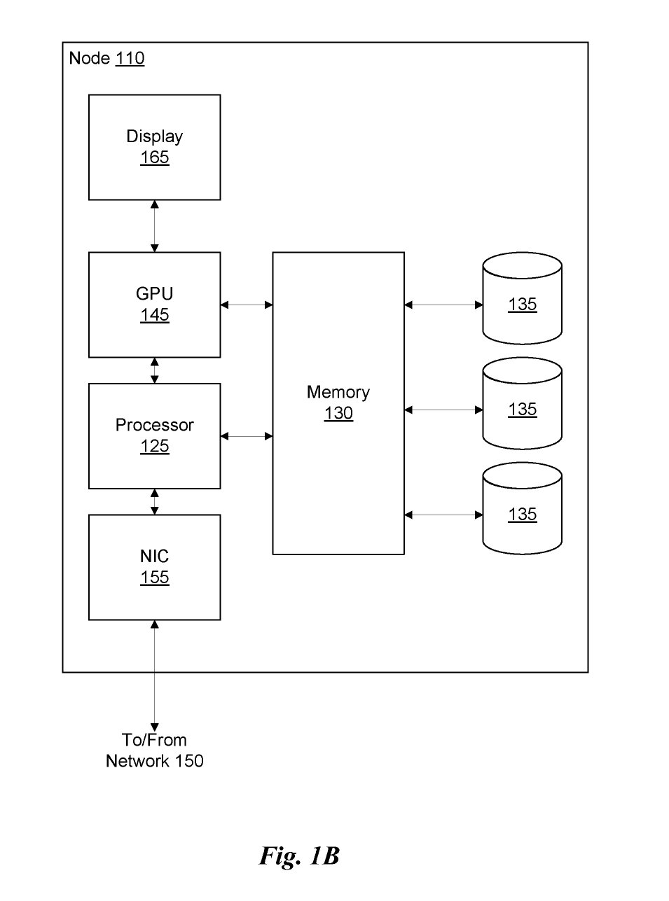

FIG. 1A illustrates a computing cluster 100, in accordance with an embodiment. The computing cluster 100 includes a plurality of nodes 110. Each of the nodes 110 may be connected to the other nodes via a network 150. In an embodiment, each node 110 may be a physical computer, including, at least, a processor, a memory, non-volatile storage, and a network interface controller (NIC). A dataset may be stored on one or more nodes 110 in memory (e.g., SDRAM) or non-volatile storage (e.g., hard disk drive). The network 150 may be a private network or a public network such as the Internet.

In another embodiment, each node 110 may be a virtual machine configured to emulate a set of hardware resources. One or more virtual machines may be executed on a hardware system including physical resources that are provisioned between the virtual machines, such as by a virtual machine monitor (VMM) or hypervisor. Virtual machines may utilize hardware resources provided as a web service, such as Amazon® EC2. Alternatively, virtual machines may utilize hardware resources hosted via a public or private network.

Each node may communicate through a communications protocols such as the Internet Protocol and Transmission Control Protocol (IP/TCP). These packet-based communications protocols enables data stored on one node 110 to be shared with other nodes 110, results from multiple nodes to be combined, and so forth. Transmitting data between nodes enables a dataset to be analyzed using parallel processing algorithms that may increase the efficiency of the analysis. For example, a MapReduce programming model is one implementation for processing large datasets using a parallel, distributed algorithm.

FIG. 1B illustrates a node 110 of the computing cluster 100, in accordance with an embodiment. As shown in FIG. 1B, a node 110 includes a processor 125, a graphics processing unit (GPU) 145, a memory 130, one or more non-volatile storage units 135, a NIC 155, and (optionally), a display 165. The processor 125 may be, e.g., a central processing unit (CPU) having one or more processing cores. The GPU 145 may be, e.g., a parallel processing unit having a large number of processing cores that include specialized hardware for processing graphics for display. The processor 125 is coupled to at least the memory 130, such as via a bus or other data communication link. However, the processor 125 may be coupled to other or all of the other components of the node 110. The GPU 145 may be connected to the processor via a high-speed serial interface such as a Peripheral Component Interconnect Express (PCIe) interface.

The memory 130 is coupled to the processor 125 and the GPU 145. The memory 130 may be, e.g., synchronous dynamic random access memory (SDRAM), which is a high-speed volatile memory that stores program instructions and data to be processed using the processor 125 and/or GPU 145. The non-volatile storage units 135 may be, e.g., hard disk drives (HDDS), solid state drives (SSD), optical media, magnetic media, Flash memory cards, EEPROMS, and the like.

The NIC 155 is coupled to the processor 125 and enables the processor 125 to transmit and receive data via the network 150. The NIC 155 may implement a wired or wireless interface to connect with the network 150.

The display 165 may be any type of display, such as a liquid crystal display (LCD) monitor, a light emitting diode (LED) monitor, a high definition television, a touch screen, and the like. The display 165 is connected to the GPU 145, such as via a high bandwidth interface including a DVI or DisplayPort interface. It will be appreciated that, in some embodiments, the display 165 may be omitted as the node 110 is utilized only for processing and any graphics displayed to a data analyst will be displayed on a different node.

Many of the components shown in FIG. 1B may be connected to a motherboard (not shown) or printed circuit board (PCB) that provides power to the components and routes data between various communications channels. Some components in addition to or in lieu of the components shown in FIG. 1 may be included in the node 110, such as bus controllers, input/output devices (i.e., a keyboard, mouse, touchpad, etc.), and the like.

In an embodiment, some of the components in the node 110 may be implemented within a system-on-a-chip (SoC). For example, a SoC may include at least one CPU core and multiple GPU cores that replace processor 125 and GPU 145. The SoC may also include the memory 130 and NIC 155 within a single package. The SoC may be coupled to a printed circuit board that includes interfaces for a display 165 and non-volatile storage units 135.

In an embodiment, each node 110 is implemented as a server blade included in a server chassis included in a data center. Multiple nodes 110 may be included in a single server chassis and multiple chassis in multiple racks and/or data centers may be included in the computing cluster 100.

Returning now to FIG. 1A, in some embodiments, a node or nodes in the computing cluster 100 may act as a client node 120. The client node 120 may be similar to nodes 110, but will typically include a display 165 that enables the data analyst to provide input and view results. The client node 120 will typically be a desktop computer, laptop computer, tablet computer, or mobile device. The client node 120 is connected to the other nodes 110 via the network 150. A data analyst may use the client node 120 to configure an exploration operation for analyzing a dataset using the computing cluster 100. In an embodiment, the client node 120 executes an application that enables a data analyst to select a dataset to be analyzed, select a machine learning algorithm to process the dataset, define a set of features in the input to the machine learning algorithm, set parameters associated with the machine learning algorithm, and schedule the analysis to be executed. The functionality of the application may be controlled through commands entered in a command line interface, or the application may implement a graphical user interface that enables the data analyst to interact with the application using common graphical features, such as windows, dialog boxes, buttons, and so forth.

In an embodiment, the client node 120 includes an operating system and a web browser that enables a web client to function as the application. The data analyst may direct the web browser to a particular website, and the client application may be delivered to the client node 120 via the network 150. The client application may include various forms or other html elements that enable the data analyst to provide various input. A scripting language may be used to pass data between the client application and a server application executed by another node 110 in the computing cluster 100.

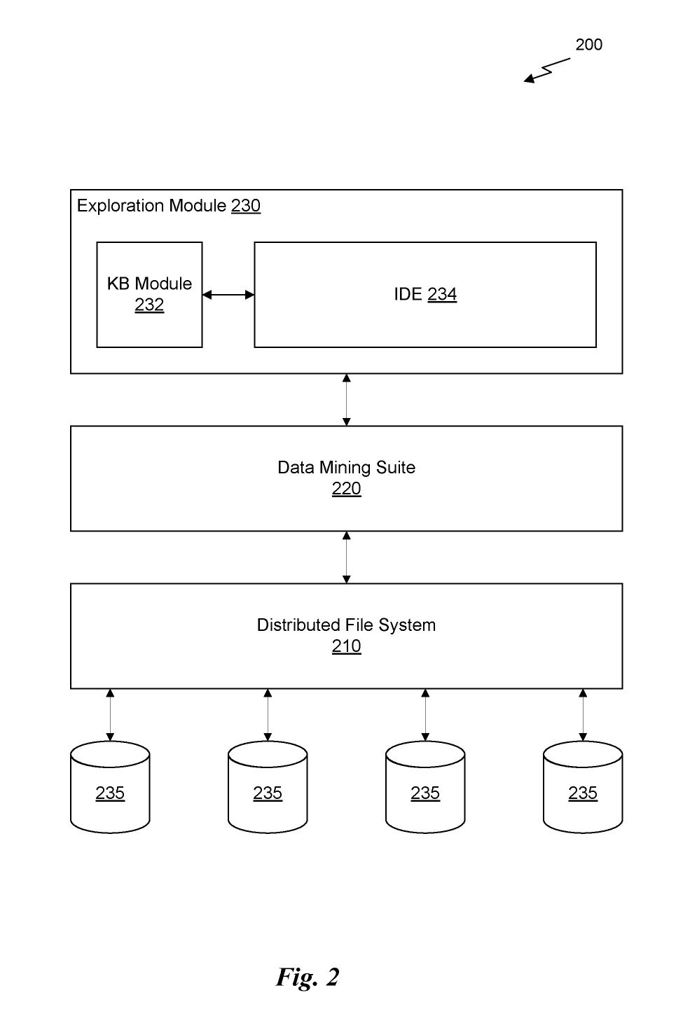

FIG. 2 illustrates a modeling environment 200, in accordance with an embodiment. The modeling environment 200 includes one or more non-volatile storage units 235 for storing a dataset. The modeling environment 200 also includes a distributed file system 210. The distributed file system 210 enables the dataset to be stored in a distributed manner across a plurality of non-volatile storage units 235. In an embodiment, the distributed file system 210 is the Apache™ Hadoop® distributed file system. Hadoop is an open source software framework that provides functions to support both the distributed storage of large datasets and distributed processing of the large datasets. The Hadoop Distributed File System (HDFS) enables the dataset to be stored on multiple non-volatile storage units 235 on two or more nodes 110. Hadoop also implements a version of MapReduce for processing the distributed dataset.

The modeling environment 200 layers a data mining (DM) suite 220 on top of the distributed file system 210. The DM suite 220 is a software platform that includes functions for processing a dataset using machine learning algorithms. The DM suite 220 may include a library of binary executables that implement various machine learning algorithms. For example, the library may include one function for processing the dataset according to a support vector machine algorithm and another function for processing the dataset according to a linear regression algorithm. The functions in the DM suite 220 may utilize the distributed file system 210 to access the dataset and may also use the MapReduce functionality of Hadoop to process the dataset in a distributed fashion.

Finally, the modeling environment 200 layers an exploration module 230 on top of the DM suite 220. The exploration module 230 enables a data analyst to run a model (i.e., exploration operation) using the dataset. In an embodiment, the exploration module 230 is a command line module that enables the data analyst to configure an exploration operation and trigger the execution of an algorithm to process the dataset using the functions of the DM suite 220. In another embodiment, the exploration module 230 includes an integrated development environment (IDE) 234 that provides a graphical user interface (GUI) that enables the data analyst to configure the exploration operations performed on the dataset and to view the results of the exploration operation.

The IDE 234 may be supplemented with a knowledge base (KB) module 232. The KB module 232 tracks the various exploration operations run by a data analyst. The KB module 232 stores an exploration operation configuration of the exploration operation when a data analyst runs the exploration operation, and analyzes the result of the exploration operation to generate at least one performance metric associated with the result. The KB module 232 may also track a time that the exploration operation was initiated and a duration required to complete execution of the exploration operation. The KB module 232 manages a database that stores entries to track the various exploration operations that have been executed. The KB module 232 may also run queries on the database to generate suggestions on how new exploration operations should be configured to assist the data analyst in configuring a different exploration operation.

The exploration module 230 may be located in a memory 130 of the client node 120 and executed by the processor 125. The DM suite 220 and/or the distributed file system 210 may also be located in the memory 130 of the client node 120 and executed by the processor 125. Alternatively, the DM suite 220 and/or the distributed file system 210 may be located remotely on a node 110 and accessed via a communications channel via the network 150. In an embodiment, an instance of the distributed file system 210 is included in the memory 130 of each node 110 and each instance of the distributed file system 210 may communicate with the other instances of the distributed file system 210 via the network 150.

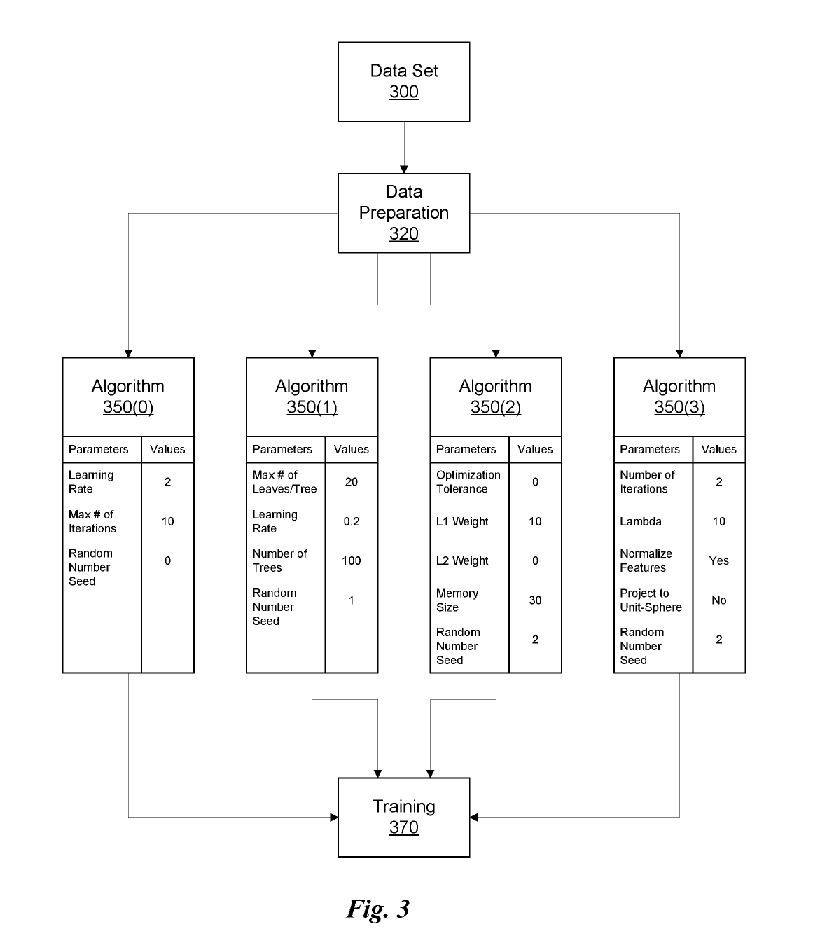

FIG. 3 illustrates a data flow for an exploration operation, in accordance with an embodiment. An exploration operation includes executing a series of instructions to process the data in the dataset according to an algorithm. The algorithm may be a machine-learning algorithm including, but not limited to, classification algorithms, regression algorithms, or clustering algorithms, for example. Examples of classification algorithms include a decision tree algorithm, a support vector machine (SVM) algorithm, a neural network, and a random forest algorithm, for example. Examples of regression algorithms include a linear regression algorithm. Examples of clustering algorithms include a K-means algorithm, a hierarchical clustering algorithm, and a highly connected subgraphs (HCS) algorithm, for example. Each machine learning algorithm may be associated with a number of parameters that can be set to configure the exploration operation. For example, parameters may include a maximum number of iterations in a linear regression algorithm, a maximum number of leaves/tree in a decision tree algorithm, and so forth.

The data flow of an exploration operation starts with a dataset 300. The dataset 300 may be stored on multiple non-volatile storage units 135 using the distributed file system 210. Examples of the dataset 300 may include census data, customer data, scientific measurement data, financial data, and the like. The dataset 300 may take a number of different formats including, but not limited to, a relational database, a key-value database, a matrix of samples, or any other technically feasible means for storing large amounts of information.

The dataset 300 is processed during a data preparation step 320. The data preparation step may be implemented by executing instructions on one or more nodes 110 of the cluster 100. In an embodiment, the exploration module 230 is configured to execute a number of instructions to process the dataset 300 in preparation for an exploration operation. The main focus of the data preparation step 320 is to generate input for the machine learning algorithm based on the dataset 300. Machine learning algorithms are typically designed to receive a large number of uniformly formatted samples of data and process the data to produce a result based on the large number of samples. Consequently, the machine learning algorithms may not be designed to process the data in a format provided by the dataset 300. Consequently, the data preparation step 320 is designed to produce data samples from the dataset 300 in a format compatible with the machine learning algorithm.

In an embodiment, the dataset 300 is processed in the data preparation step 320 to generate a matrix as input to the machine learning algorithm, each row of the matrix corresponding to a sample of the dataset 300 and each column of the matrix corresponding to a feature of the dataset 300. For example, if the dataset 300 represents census data, each sample may represent the collective information for one individual and each feature may represent one characteristic of that individual (e.g., age, race, location, income, size of household, etc.).

Features may refer to data included in the dataset 300 as well as data derived from the dataset 300. For example, a direct feature may be an age of each customer included in a customer database. As another example, a derived feature may be “a number of male students in each class” or “a number of people between the ages of 18 and 35 in each state.” While the dataset 300 may not explicitly include the values for the derived features, these values can be calculated based on the data in the dataset 300. Populating the values of samples for one or more features based on the dataset 300 may be performed during the data preparation step 320. In an embodiment, the data preparation step 320 may be performed each time a new exploration operation is executed to generate an input for the machine learning algorithm. In another embodiment, the data preparation step 320 may be performed once to generate the input corresponding to the dataset 300 and the input may be saved for multiple exploration operations. Saving the populated feature fields of the input may be beneficial when the dataset 300 cannot be amended, such as by adding new entries to the dataset 300, or for processing the input by multiple machine learning algorithms in different exploration operations.

Each of the features populated in the input may be normalized. For example, in an embodiment, a range of values for a feature (i.e., independent variable) of the dataset 300 may be reduced to a fixed scale (e.g., [0, 1]). In another embodiment, features may be standardized such that a mean of the values for the feature is equal to zero and the variance of the values for the feature is equal to a unit-variance. In yet another embodiment, the values of the feature may be scaled by the Euclidean length of the vector of sample values for the feature. Various other techniques for normalizing the features may be utilized as well. In an embodiment, the techniques for normalization used for each feature may be included in the exploration operation configuration for an exploration operation.

Once the data preparation step 320 has been completed, algorithm 350 is applied to the input to perform the exploration operation. Each exploration operation may specify a particular algorithm 350 utilized within the exploration operation. Different algorithms 350 may be utilized to process the same input. Each algorithm 350 may require a set of parameters to be specified by a data analyst that determines how the algorithm 350 behaves. As shown in FIG. 3, a first algorithm 350(0) is a boosted decision tree algorithm and requires input parameters for a learning rate, a maximum number of iterations, and a random number seed. A second algorithm 350(1) is an averaged perception algorithm and requires input parameters for a maximum number of leaves per tree, a learning rate, a number of trees, and a random number seed. A third algorithm 350(2) is a logistic regression algorithm and requires input parameters for an optimization tolerance, an L1 regularization weight, and L2 regularization weight, a memory size for L-BGFS (Limited memory Broyden-Fletcher-Goldfarb-Shanno), and a random number seed. A fourth algorithm 350(3) is a logistic boosted decision tree algorithm and requires input parameters for a number of iterations, lambda, normalize features (Boolean), project to the unit-sphere (Boolean), and a random number seed. It will be appreciated that the number of algorithms or types of algorithms is not limited by the examples shown in FIG. 3 and that other algorithms in addition to or in lieu of the algorithms shown in FIG. 3 are within the scope of the present disclosure.

The heart of an exploration operation is processing the defined input (i.e., a number of samples for a set of defined features) by the algorithm 350. In simple systems, the input populated based on the dataset 300 may be stored on a single node 110 and processed by a machine learning algorithm 350 on that node 110. However, the size of the input (i.e., the number of samples and/or features per sample) must be relatively small in order to be stored on a single node, and limiting the processing of the input to a small number of processing cores (of either processor 125 or GPU 145) within a single node 110 may require a longer time to process the input in order to produce a result. More often, the processing load will be distributed among a plurality of nodes 110, and the algorithm 350 will be implemented using distributed processing techniques, such as using MapReduce of Hadoop to process subsets of samples of the input to produce intermediate results on each node 110 and then combining the intermediate results to generate a final result.

Once the algorithm 350 has finished processing the input and generated a result, the result may be used to train 370 the algorithm 350. The particular implementation of the training step 370 may depend on the algorithm 350 being trained. In some cases, the training step 370 may include analyzing the input and result to determine adjustments to various parameters associated with the algorithm 350. For example, in an algorithm 350 that utilizes a neural net, the training step 370 may involve calculating new weights associated with each neuron in the neural net. In another embodiment, the training step 370 may include comparing the result with a simulated expected result. In some embodiments, the training step 370 may be performed prior to execution of the algorithm 350. In other words, the training step 370 may be independent of the exploration operation in that a known input is processed by the algorithm 350 and parameters of the algorithm 350 are adjusted until a result produced by the algorithm 350 approximates an expected result. Once the algorithm 350 is tuned during the training step 370, the algorithm 350 may be utilized to process the input populated based on the dataset 300.

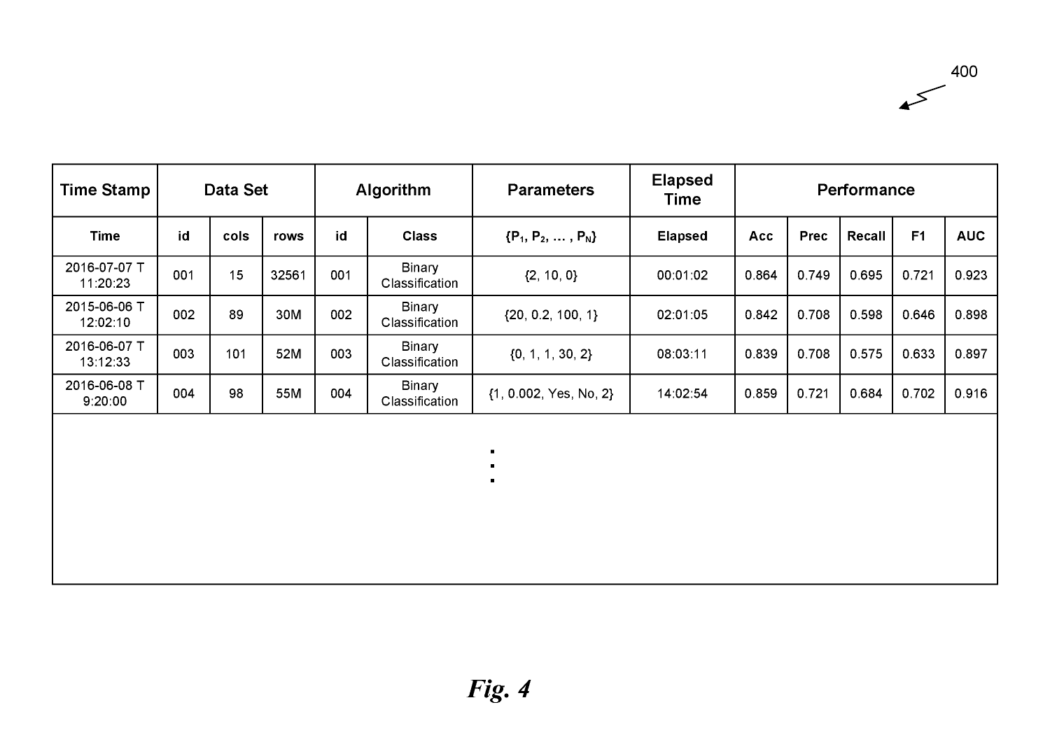

FIG. 4 illustrates a knowledge base 400 maintained by the knowledge base module 232 of FIG. 2, in accordance with an embodiment. In an embodiment, the knowledge base 400 is a relational database that includes entries for each exploration operation executed by a data analyst. Each time an exploration operation is run, an entry is added to the knowledge base 400. The entry may include fields for a timestamp, a dataset, an algorithm, parameters, elapsed time, and performance metrics, among other fields. As shown in FIG. 4, an embodiment of the knowledge base 400 includes an entry that stores a timestamp specifying when the exploration operation was initiated, an identifier specifying the dataset processed during the exploration operation, a number of columns (i.e., features) in the input, a number of rows (i.e., samples) in the input, an identifier specifying an algorithm utilized to process the dataset, a classification of the algorithm, a list of zero or more parameter values utilized to configure the algorithm, an elapsed time indicating the duration of the exploration operation, and a plurality of performance metrics that include: (1) an accuracy associated with the result; (2) a precision associated with the result; (3) a recall associated with the result; (4) an F1 score associated with the result; and (5) an Area Under Curve (AUC) associated with the result. These performance metrics may be calculated by the KB module 232 once the result is generated by the algorithm 350. It will be appreciated that the fields shown in FIG. 4 are merely examples of an entry of the knowledge base 400 and are not intended to be limiting. For example, the entry may include an identifier for the exploration operation, different statistical measures as performance metrics, start times and end times for the exploration operation (in addition to or in lieu of the elapsed time), and so forth. The parameters field may include a list of parameter values of variable size, or may include a pointer to a file that stores the parameter values utilized to configure the exploration operation. Because each algorithm 350 may be associated with a different number or type of parameters, the entry in the relational database needs to be flexible to store these parameters. In addition, the entry may include a list of the features that were defined for the input of the algorithm 350 and populated based on the dataset 300 during the data preparation step 320.

Importantly, the knowledge base 400 may be mined to find suggestions for configuring an exploration operation. For example, the knowledge base 400 may be queried to return a subset of exploration operations that have been run for a specific algorithm or classification of algorithm. Then, the subset of exploration operations may be sorted to determine an exploration operation configuration for the exploration operation that maximizes a particular performance metric. Alternatively, the knowledge base 400 may be queried to return a subset of exploration operations that have been run on a particular dataset 300. Then, the subset of exploration operations may be sorted to find the algorithms that can be completed within a given time period (i.e., elapsed time). In yet another alternative, a data analyst can query the knowledge base 400 to find all exploration operations performed by a particular data analyst or performed in a particular date range. This may allow the data analyst to select a particular exploration operation to repeat the analysis on a different dataset.

In an embodiment, the knowledge base 400 includes entries from multiple data analysts for exploration operations run on the cluster 100 or even different clusters of nodes. The knowledge base 400 may be modified by different client nodes 120 being run by different data analysts and shared among a plurality of client nodes 120. In an embodiment, the knowledge base 400 is stored on a server accessible by a server application. The data analyst can initiate queries of the knowledge base 400 using the IDE 234 on the client node 120 by communicating with the server application via the network 150. The server application may query the knowledge base 400 and return a result of the query to the client node 120. Multiple clients can access and query the knowledge base 400, and new entries can be added to the knowledge base 400 by different clients connected to the server via the network 150.

In an embodiment, the exploration module 230 is configured to schedule exploration operations for execution that are not initiated by a data analyst. When the DM suite 220 is idle, the exploration module 230 may utilize the DM suite 220 to run various exploration operation configurations for exploration operations in order to generate results to populate the knowledge base 400. For example, a particular dataset, a defined input based on the dataset, and a particular algorithm may be selected and a plurality of exploration operations may be run overnight using different parameters. The exploration module 230 may vary the parameters slightly over a particular range for each exploration operation of the plurality of exploration operations. This automatic scheduling of multiple exploration operations generates entries in the knowledge base 400 that can then be utilized to inform a data analyst which combination of parameter values maximize accuracy, or precision, for example. In another embodiment, the exploration module 230 may implement tools that enable a data analyst to schedule a group of exploration operations and vary the parameters over each exploration operation in the group. Thus, a data analyst can study how changing the number of iterations or a number of trees, for example, affects the accuracy of an algorithm.

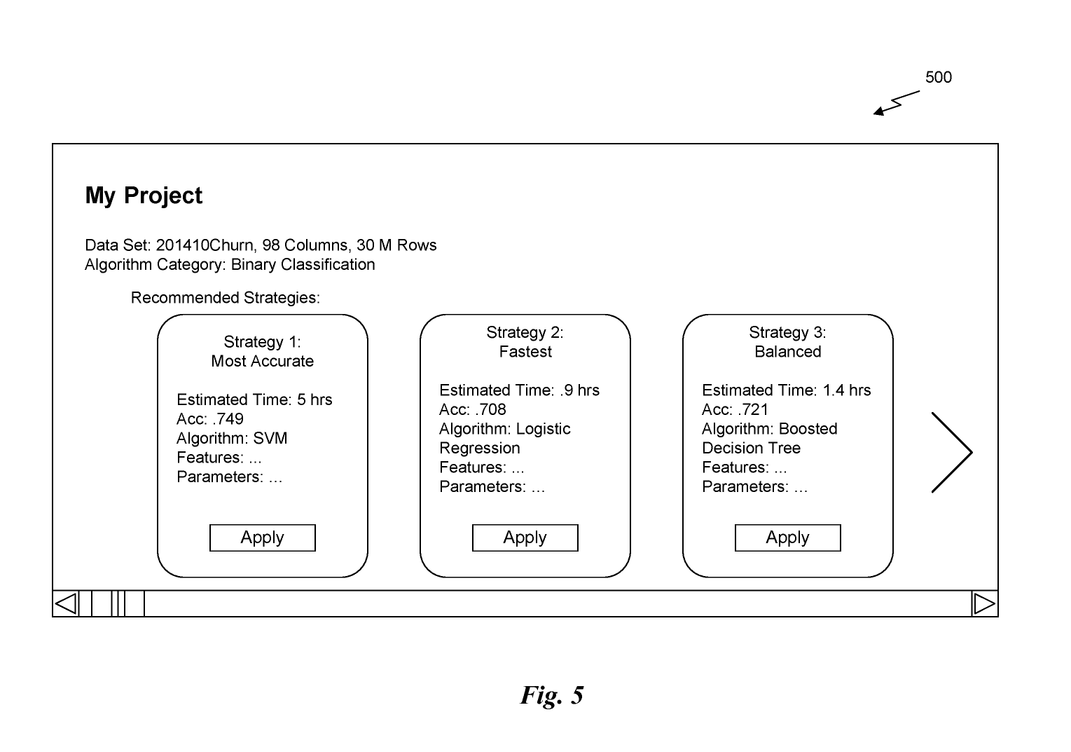

FIG. 5 illustrates a GUI 500 implemented by the IDE 234 of FIG. 2, in accordance with an embodiment. As shown in FIG. 5, the knowledge base 400 may be utilized to generate suggested exploration operation configurations for an exploration operation that can be selected by a data analyst. The GUI 500 includes information such as a title of a project being worked on by the data analyst, a name of the dataset currently selected to be modeled, and a name of the category of algorithms that will be used to process the dataset. The knowledge base 400 may be queried to return a subset of exploration operations that have been previously performed using this category of algorithms. Then, the subset of exploration operations may be analyzed to determine exploration operation configurations utilized during previously executed exploration operations, wherein the exploration operation configurations maximize or minimize a particular performance metric or combination of performance metrics. Alternative, the knowledge base 400 may be queried to return a subset of exploration operations that have been previously performed using this category of algorithms for this particular dataset. The subset of exploration operations may then be sorted to select particular exploration operation configurations for the exploration operation that maximize or minimize a particular performance metric or combination of performance metrics.

In an embodiment, a suggested exploration operation configuration for the exploration operation may be determined using a formula that combines one or more performance metric values and time statistics stored in the entry of the knowledge base 400 to generate a value for a suggestion metric. The suggested exploration operation configuration may be read from the entry corresponding with the maximum suggestion metric. For example, a suggestion metric may calculate a weighted sum of one or more performance metrics and an inverse of elapsed time as follows:

$${m}_{s} = \frac{{w}_{0}}{{t}_{elapsed}} + {\sum }_{i = 1}^{n} {w}_{i} {p}_{i} \qquad ( Eq . 1 )$$

where the terms wᵢ are the weight values, the term t_{elapsed} is an elapsed time required to complete execution of the exploration operation, and the terms pᵢ are n performance metrics. Any of these terms may be omitted from the calculation of the suggestion metric. For example, the suggestion metric may be calculated using only the accuracy performance metric (and not elapsed time or any other performance metric). In another example, the suggestion metric may be calculated using the accuracy and the precision performance metrics as well as the elapsed time. The weights may be selected in order to balance the importance of various performance metrics. In an embodiment, the suggested exploration operation configurations provided to the data analyst utilize pre-set equations and weights for calculating the suggestion metric for each entry to select the suggested exploration operation configuration for the exploration operation. In another embodiment, the data analyst may adjust the weights used to calculate the suggestion metric or select which terms (i.e., performance metrics) to include in the calculated suggestion metric. For example, the data analyst may be given a dialog box that asks the data analyst to select one or more performance metrics he would like to optimize and also provide sliders to adjust the relative importance (weights) of each selected performance metric. The inputs provided by the data analyst may set the weights for each term of Equation 1, which is then used to calculate a suggestion metric value for each entry of a subset of entries queried from the knowledge base 400. The maximum suggestion metric for the entries in the subset of entries may be selected and displayed to the data analyst in the GUI 500. It will be appreciated that the suggestion metric example provided in Equation 1 is only one example of a formula for calculating the suggestion metric. In other embodiments, the suggestion metric may be calculated using any formula or function based on one or more parameters, including but not limited to parameters such as an elapsed time, features, a size or distribution of the dataset, and the performance metrics.

As shown in FIG. 5, the GUI 500 includes a number of boxes that highlight different strategies for processing a dataset. A first strategy is shown in a first box, a second strategy is shown in a second box, and a third strategy is shown in a third box. The first strategy corresponds with a suggested exploration operation configuration for the exploration operation that corresponds with a maximum accuracy. In other words, the suggestion metric may be calculated with all weight terms set to zero except the weight term associated with the accuracy performance metric. The entry corresponding to the maximum suggestion metric in this calculation is selected as the suggested exploration operation configuration for the first strategy and displayed in the first box. The data analyst may select this strategy, which will automatically configure the exploration operation for the selected dataset utilizing the parameters stored in that entry of the knowledge base 400.

The second strategy corresponds with a suggested exploration operation configuration for the exploration operation that corresponds with a minimum elapsed time. The third strategy corresponds with a balanced approach that combines a measure of accuracy with the elapsed time. Additional strategies may also be selected by scrolling to the right or selecting the arrow at the right of the GUI 500.

In an embodiment, the data analyst may select a suggested exploration operation configuration, which populates the parameters for an exploration operation. However, before the exploration operation is executed, the data analyst may be given the opportunity to change any of the configured parameters. Once the data analyst is satisfied with the exploration operation configuration for the exploration operation, the data analyst may run the exploration operation or schedule a time to run the exploration operation.

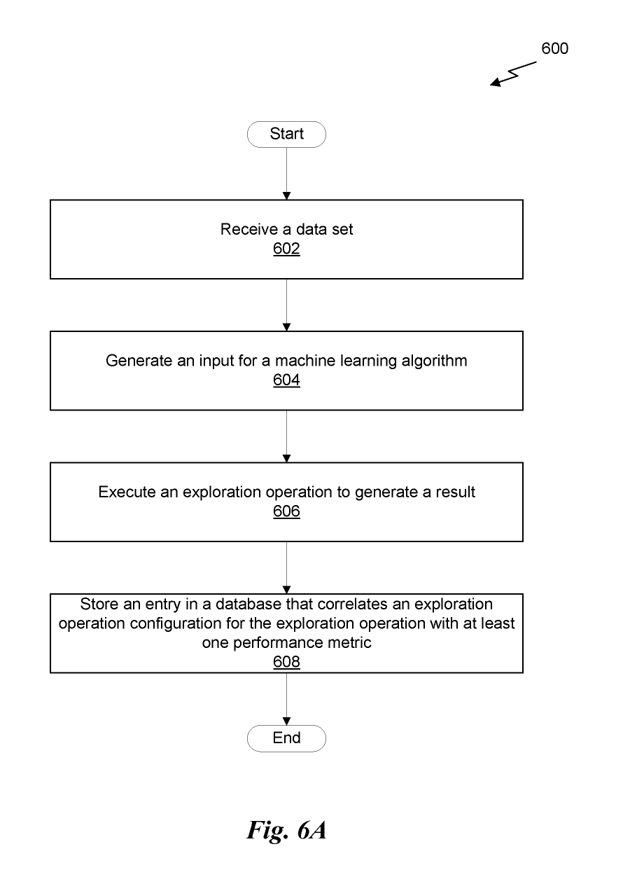

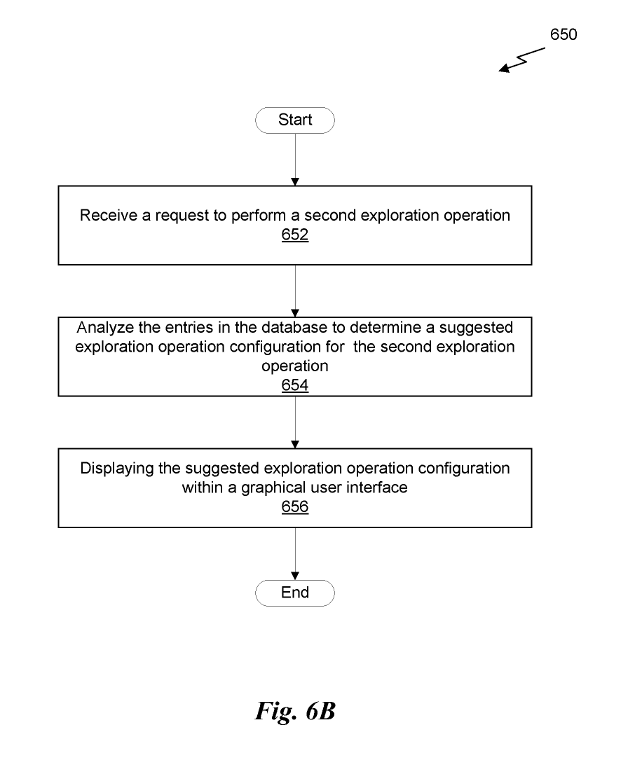

FIG. 6A is a flowchart of a method 600 for populating a knowledge base 400, in accordance with an embodiment. At step 602, a dataset 300 is received by a node. The dataset 300 may be stored on one or more nodes. In an embodiment, the dataset 300 is stored on two or more nodes using a distributed file system. At step 604, an input for a machine learning algorithm 350 is generated based on the dataset 300. In an embodiment, the dataset 300 is processed to populate samples comprising one or more values for a set of features defined for the dataset 300. The input may define features extracted directly from the dataset 300 as well as features derived from the dataset 300.

At step 606, an exploration operation is executed to generate a result. In an embodiment, an exploration operation is initiated using tools implemented within the IDE 234. The IDE 234 may call functions in the DM suite 220 to run the exploration operation on the input generated from the dataset 300. The DM suite 220 utilizes the distributed file system 210 to process the input on multiple nodes 110 in the cluster 100. The result generated by the DM suite 220 is returned to the IDE 234 and displayed in the GUI 500. The KB module 232 may also process the result and calculate one or more performance metrics based on a statistical analysis of the result.

At step 608, an entry is stored in the knowledge base 400 that correlates an exploration operation configuration for the exploration operation with at least one performance metric. Each performance metric in the at least one performance metric is a value used to evaluate the result. In an embodiment, an exploration operation configuration for the exploration operation includes fields, stored in the entry of the knowledge base 400, that specify an identifier that specifies the dataset 300, an identifier that specifies the machine learning algorithm 350, a list of one or more features included in the input to the machine learning algorithm 350, a list of normalization methods corresponding to each feature of the one or more features, and a list of zero or more parameter values utilized to configure the machine learning algorithm 350. The entry correlates the exploration operation configuration for the exploration operation with the at least one performance metric by storing fields in the entry of the knowledge base 400 that store values for the performance metric calculated for the result generated by the exploration operation. The entries in the knowledge base 400 may be stored in a memory 130 of the client node 120 or stored in one or more nodes 110 using the distributed file system 210.

FIG. 6B is a flowchart of a method 650 for utilizing the knowledge base 400 to generate suggested exploration operation configurations for an exploration operation, in accordance with an embodiment. The method 650 may be performed after at least one exploration operation has been performed on a dataset such that the knowledge base 400 includes at least one entry. At step 652, a request to perform a second exploration operation is received. The second exploration operation may be performed on a dataset that has previously been analyzed in one or more previous exploration operations, such that the knowledge base 400 includes at least one entry associated with the second dataset, or a different dataset that has not yet been analyzed and, therefore, does not have an associated entry in the knowledge base 400. In an embodiment, the request may comprise a data analyst selecting a dataset to be modeled using a particular category of algorithm within the IDE 234.

At step 654, the entries in the knowledge base 400 are analyzed to determine a suggested exploration operation configuration for the second exploration operation. In an embodiment, the knowledge base 400 is queried to select all entries in the knowledge base 400 associated with a second dataset corresponding to the second exploration operation. The subset of entries associated with the second dataset may be entries for exploration operations performed utilizing that particular dataset, a similar dataset, a particular category of machine learning algorithm on similar datasets (or any dataset), and/or a particular machine learning algorithm on similar datasets (or any dataset). In other words, entries associated with a particular dataset may be associated with the second dataset if the two datasets are similar but not equal according to some criteria; i.e., similarity may be measured using a criteria such as classification of the data, number of samples in the dataset within a given range, the types of features derived from the dataset, or any other criteria used to evaluate and/or compare two datasets. The subset of entries may be sorted to select an entry associated with a particular performance metric. In another embodiment, a suggestion metric is calculated for each entry in the subset of entires based on the values for one or more performance metrics and/or an elapsed time, and the entries are sorted based on the suggestion metric. A particular entry corresponding to minimum or maximum of the suggestion metric is selected as the suggested exploration operation configuration for the second exploration operation. It will be appreciated that the subset of entries may be associated with a plurality of different datasets, which may or may not include the second dataset to be analyzed during the second exploration operation.

At step 656, the suggested exploration operation configuration is displayed within a GUI 500. The GUI 500 may include elements that enable the data analyst to select the suggested exploration operation configuration, which causes the exploration module 210 to configure the second exploration operation according to the parameters included in the entry of the knowledge base 400 corresponding to the suggested exploration operation configuration. In an embodiment, selecting the suggested exploration operation configuration automatically runs the second exploration operation. In another embodiment, selecting the suggested exploration operation configuration populates a number of parameters for the selected algorithm and waits for the data analyst to modify any parameters prior to execution of the second exploration operation.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A computer-implemented method for tracking modeling of datasets, comprising:
executing, via at least one node, an exploration operation to generate a result, wherein the exploration operation utilizes a machine learning algorithm to process an input, wherein the input is based on a dataset; and
storing an entry in a database that correlates an exploration operation configuration for the exploration operation with at least one performance metric, wherein the at least one performance metric is used for evaluating the result.

2. The method of claim 1, further comprising generating the input for the machine learning algorithm based on the dataset by performing, via at least one node, at least one of extracting a plurality of samples from the dataset to include in the input, wherein each sample in the plurality of samples comprises one or more values corresponding to features of the input, or calculating at least one value per sample for one or more derived features of the input.

3. The method of claim 1, wherein the exploration operation configuration for the exploration operation comprises an identifier that specifies the dataset, an identifier that specifies the machine learning algorithm, a list of one or more features included in the input to the machine learning algorithm, a list of normalization methods corresponding to each feature of the one or more features, and a list of zero or more parameter values utilized to configure the machine learning algorithm.

4. The method of claim 3, wherein the machine learning algorithm is selected from a group of algorithms consisting of a classification algorithm, a regression algorithm, or a clustering algorithm.

5. The method of claim 3, wherein the entry includes an elapsed time required to execute the exploration operation, and wherein the at least one performance metric includes at least one of an accuracy associated with the result, a precision associated with the result, a recall associated with the result, an F1 score associated with the result, and an Area Under Curve (AUC) associated with the result.

6. The method of claim 1, wherein the dataset is stored on a distributed file system comprising at least two nodes.

7. The method of claim 1, further comprising:
receiving a request to perform a second exploration operation; and
analyzing the entries in the database to determine a suggested exploration operation configuration for the second exploration operation.

8. The method of claim 7, wherein determining the suggested exploration operation configuration comprises:
querying the database to select all entries associated with a second dataset corresponding to the second exploration operation; and
analyzing the selected entries to determine exploration operation configurations utilized during previously executed exploration operations that maximize or minimize a particular performance metric.

9. The method of claim 7, further comprising displaying the suggested exploration operation configuration within a graphical user interface.

10. A system for tracking modeling of datasets, comprising:
a cluster including a plurality of nodes, the cluster including at least one node including a processor configured to:
execute an exploration operation to generate a result, wherein the exploration operation utilizes a machine learning algorithm to process an input, wherein the input is based on a dataset, and
store an entry in a database that correlates an exploration operation configuration for the exploration operation with at least one performance metric, wherein the at least one performance metric is used for evaluating the result.

11. The system of claim 10, wherein the processor is further configured to generate the input for the machine learning algorithm based on the dataset by performing, via at least one node, at least one of extracting a plurality of samples from the dataset to include in the input, wherein each sample in the plurality of samples comprises one or more values corresponding to features of the input, or calculating at least one value per sample for one or more derived features of the input.

12. The system of claim 10, wherein the exploration operation configuration for the exploration operation comprises a timestamp that specifies when the exploration operation was executed, an identifier that specifies the dataset processed during the exploration operation, an identifier that specifies an algorithm utilized to process the dataset, a list of zero or more features defined for the dataset, and a list of zero or more parameter values utilized to configure the algorithm.

13. The system of claim 12, wherein the machine learning algorithm is selected from a group of algorithms consisting of a classification algorithm, a regression algorithm, or a clustering algorithm.

14. The system of claim 12, wherein the entry includes an elapsed time required to execute the exploration operation, and wherein the at least one performance metric includes at least one of an accuracy associated with the result, a precision associated with the result, a recall associated with the result, an F1 score associated with the result, and an Area Under Curve (AUC) associated with the result.

15. The system of claim 10, wherein the dataset is stored on a distributed file system comprising at least two nodes.

16. The system of claim 10, the processor further configured to:
receive a request to perform a second exploration operation; and
analyze the entries in the database to determine a suggested exploration operation configuration for the second exploration operation.

17. The system of claim 16, wherein determining the suggested exploration operation configuration comprises:
querying the database to select all entries associated with a second dataset corresponding to the second exploration operation; and
analyzing the selected entries to determine exploration operation configurations utilized during previously executed exploration operations that maximize or minimize a particular performance metric.

18. The system of claim 16, the processor further configured to display the suggested exploration operation configuration to a data analyst within a graphical user interface.

19. A non-transitory computer-readable media storing computer instructions for tracking modeling of datasets that, when executed by one or more processors, cause the one or more processors to perform the steps of:
executing an exploration operation to generate a result, wherein the exploration operation utilizes a machine learning algorithm to process an input, wherein the input is based on a dataset; and
storing an entry in a database that correlates an exploration operation configuration for the exploration operation with at least one performance metric, wherein the at least one performance metric is used for evaluating the result.

20. The non-transitory computer-readable media of claim 19, the steps further comprising:
receiving a request to perform a second exploration operation; and
analyzing the entries in the database to determine a suggested exploration operation configuration for the second exploration operation.
